(19) United States
(12) Patent Application Publication
(10) Pub. No.: US 2012/0190131 A1
(43) Pub. Date: Jul. 26, 2012

(54) Biosensor Electronics

(76) Inventor: Vlad Joseph Novotny, Los Gatos, CA (US)

(21) Appl. No.: 13/355,489

(22) Filed: Jan. 21, 2012

Related U.S. Application Data
(60) Provisional application No. 61/435,038, filed on Jan. 21, 2011.

(51) Int. Cl. G01N 27/60

(52) U.S. Cl. 436/501; 422/69; 422/98

(57) ABSTRACT

The electrostatic resonators of bridge, cantilever and comb type or piezoelectric resonators with detection electronics are key components of chemical, biological, biochemical and biomedical sensors with sensitivity down to the single molecule detection of ligands. The detection electronics relies on measurement of frequency changes of resonators using phase or signal comparator. The large arrays of these sensors with individual or common sensing circuitry improve detection sensitivity, selectivity and lower incidence of false positives and negatives.

### RELATED U.S. APPLICATION DATA

Provisional application No. 61/435,038 filed on Jan. 21, 2011.

### BACKGROUND

This description relates to Nano-Electro-Mechanical Systems (NEMS) and Complementary Metal Oxide Semiconductor (CMOS) circuitry for detection of chemical and biological agents, referred to as ligands, with sensitivity down to one molecule. NEMS are sensors or actuators that have critical dimensions in nanometer range.

Sensitive detection of gaseous compounds such as explosive vapors, chemical weapons or environmental polution normally requires sophisticated and expensive instrumentation. Such detection is usually carried out with optical spectrometers or quadrupole, ion trap and time of flight mass spectrometers.

Detection of biological agents is typically performed in liquids using chemical or biological assays that rely on the detection of intrinsic or covalently-attached fluorescent or ultraviolet labels, chemical or electrochemical luminescence, or radioactive labels. These approaches often limit the sensitivity of the assay method and also require expensive equipment. Detection of biological agents can be also performed without labeling with techniques such as surface plasmon resonance, waveguide resonance, electrochemical methods, but such techniques have typically lower sensitivity than labeled methods and limitations including high cost, large size, high electrical power and operation requiring skilled personnel.

None of these conventional techniques is sufficiently sensitive to detect single molecules or have sufficient resolution to differentiate between molecules that differ in mass by several atomic mass units. The equipment used is not portable or easily operated by the non-specialist. Therefore, these techniques are unsuitable for many personalized medical, wellness and other mobile applications. Portable, robust, easy-to-use clinical measurements enable individuals and medical facilities such as doctor's offices, pharmacies, and diagnostic laboratories to obtain clinically meaningful information reliably and at low cost. There is need to realize detection with the simple devices that have extreme sensitivity for chemical or biological molecules (such as proteins), and small biological agents (e.g., viruses and bacteria), very high specificity for detection of target species, low rate of false positives and negatives and low cost.

### SUMMARY

The electrostatic or piezoelectric resonators are the key components of sensors for detection of chemical and biological ligands that range from very small molecules to viruses and bacteria. The detection is based on sensing frequency change or phase change associated with resonator mass increase due to specific interaction of these target materials with receptors that are attached to resonators. Large arrays of sample and reference sensors and fast detection circuitry are employed for very sensitive detection. The electrical architecture and circuitry for sensitive detection of ligands are described.

### DESCRIPTION OF DRAWINGS

FIG. 1: Schematic operational principles for detection of ligands, L, by increase in mass of the resonator resulting from physical adsorption or chemical reactions of ligands, L, with receptors, R, present on the resonator. The initial state is shown in 1a, the state during physical adsorption or chemical reaction in FIG. 1b and the final state for detection in FIG. 1c.

FIG. 2: Typical dependence of the resonator signal, S, and phase, φ, on frequency, f, in the initial state, before (b) exposure to the ligands and in the final state, after (a) the interaction of the ligands with the receptors on the resonator surface.

FIG. 3: The side view (a) and top view (b) of electrostatic comb resonator. Driving and sensing circuitry is shown schematically.

FIG. 4: A side view (a) and top view (b) of the single element piezoelectric resonator with hinges having the piezoelectric driving and sensing functionality. Driving and sensing circuitry is shown schematically.

FIG. 5: A schematic diagram of the two dimensional array of resonators with driving and detection circuits.

FIG. 6: The simplified diagram of the electrical circuit for the detection of small changes of resonant frequency or phase of resonance.

FIG. 7: The system diagram of the architecture for detection of single molecules, viruses or bacteria.

### DETAILED DESCRIPTION

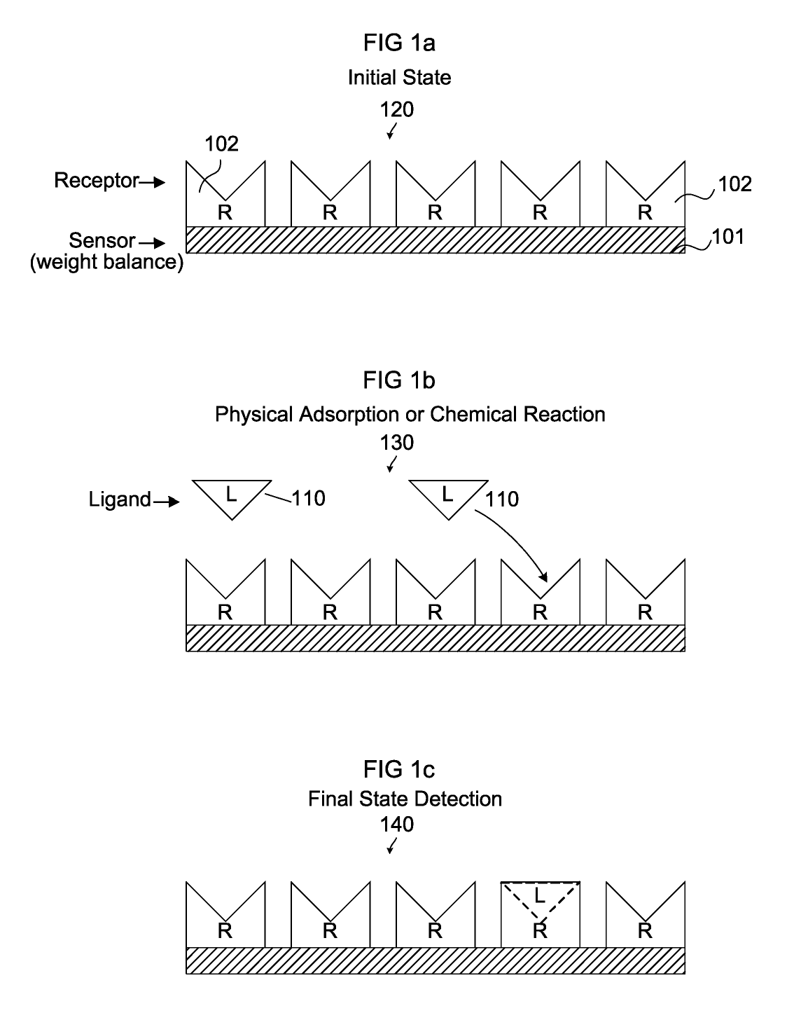

The operational principle for the detection of chemical and biological species also referred to here as ligands, L, targets, analytes or antigens is shown in FIG. 1. The most important component of the sensing system is the resonator 101 with receptors, R, attached to it. The receptors, R, 102 can be antibodies, surface groups on the resonator surface or other molecules interacting with ligands, L, 110, at the sensor resonator surface. This interaction is the result of either specific noncovalent binding or chemical reaction between receptor and ligand on the surface of the resonator 101. Specific binding between receptor and ligand illustrated schematically in FIG. 1 leads to the mass increase of the resonator and corresponding decrease of the resonant frequency or shift of the phase that are detected.

The receptors, R, 102 are selected so that they will interact only with specific ligands, L, 110. Receptors are deposited on the whole surface of the sensor as shown in FIG. 1 or are deposited only in known, specific locations on the sensor surface. The initial state of the sensor 120 with deposited receptors 102, the state 130 after introduction of ligands 110 and the final, bound state 140 are depicted in FIG. 1. In another case, the receptors 102 can be deposited only in the specific location for simplified, but less sensitive detection. Ideally, different ligands, L, are distinguishable because noncovalent binding or chemical reactions of receptor, R, and ligand, L, are specific for particular ligand and/or the sensing system has sufficient sensitivity to differentiate closely related compounds that have similar mass.

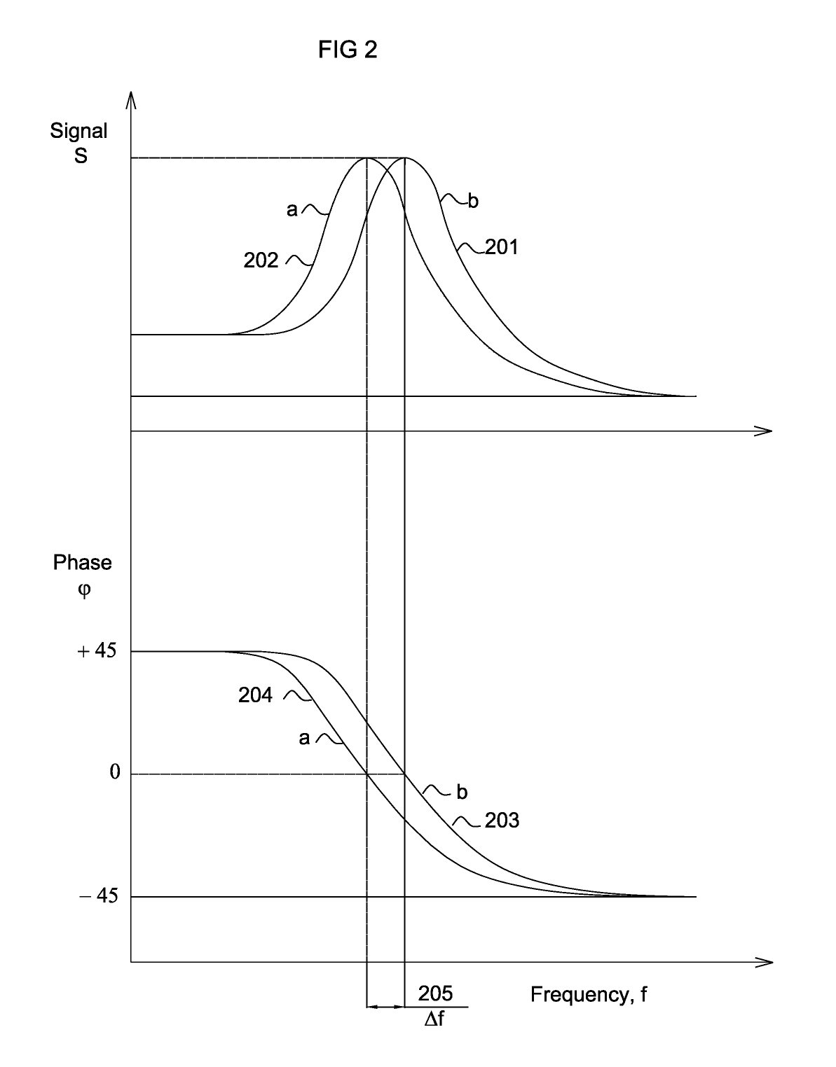

Upon binding, the mass of the ligand is added to the total weight of the resonator. This change alters resonator response, such as its resonance frequency and phase. The typical initial and final signals are schematically illustrated in FIG. 2, where the resonator signal amplitude, S, and the phase, φ, are plotted as a function of frequency, f. The initial resonator frequency response is represented by the curve (b) 201, while the final resonator amplitude is represented by the curve (a) 202. The corresponding initial phase is depicted by the curve (b) 203 and the final phase by the curve (a) 204. The frequency shift Δf, marked as 205 in FIG. 2, is directly related to the mass of the ligand added to the resonator mass.

This principle can be applied in the detection of a wide variety of chemical and biological analytes. For example, this type of sensor can detect antigens, antibodies, enzymes, proteins or their respective substrates/inhibitors, hormone ligands or their respective receptors, cells or cellular effectors, viral particles or biomolecules and biological molecules that specifically bind to viral proteins at the particle surface. In all cases, one of the binding components—receptor is fixed to the resonator surface or is the part of the resonator surface; the other component—ligand is added in gas, or liquid in solution, suspension, or emulsion.

The detection of chemical and biological species is based on the determination of change of resonant frequency or phase of the bridge, cantilever or comb electrostatic resonators or piezoelectric resonator caused by adsorption or reaction of the ligands, L, with the receptors, R, on their surface.

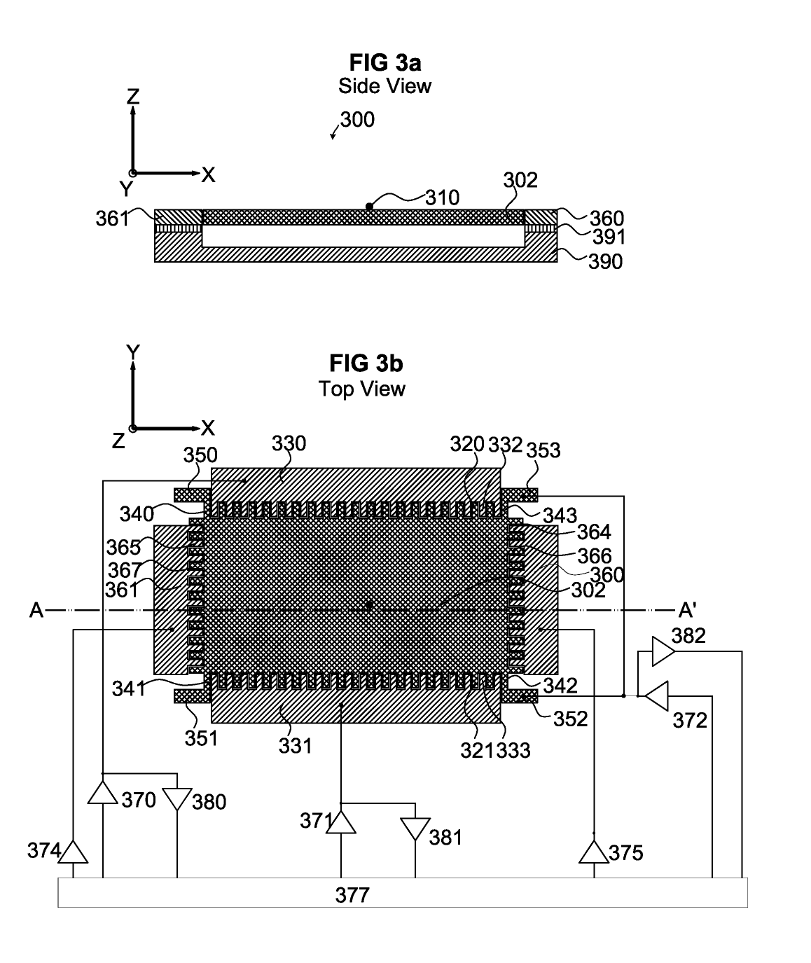

One embodiment of electrostatic resonator is shown in FIG. 3 using electrostatic comb resonator, while other electrostatic resonators are disclosed in Utility patent application Ser. No. 13/209,442. The sensitivity of the electrostatic comb resonator can be optimized by using multiple teeth with the movable and the static parts of the comb driver and sensor and by separating the driving and sensing parts of the device to reduce the noise. The resonator consists of movable central plate 302 that has movable teeth 320 and 321 attached to it. The static teeth 332 and 333 interdigitate the movable teeth 320 and 321 with small gaps between them. The complete movable structure is connected by the hinges 340-343 to the posts 350-353 respectively that reside on the substrate 390. The posts 350-353 are isolated electrically from the static teeth blocks 330 and 331 and from the substrate 390. When the substrate 390 is not electrically insulating, the dielectric layer 391 is added between the substrate 390 and posts 350-353. In addition, the stationary blocks 330 and 331 and stationary teeth 332 and 333 that are physically residing on the substrate 390 are electrically isolated from the substrate 390 by the same dielectric isolation layer 391. In addition, the driving teeth are separated from sensing teeth for increased sensitivity of detection.

The movable, driving combs 366 and 367 are placed on the movable plate 302 and the corresponding stationary, driving combs 364 and 365 are defined in driving blocks 360 and 361. The driving potentials are applied between driving electrode 366 and the movable plate 302 to displace the movable plate 302 in the positive x direction and between driving electrode 365 and the movable plate 302 in order to displace the movable plate 302 in the negative x direction. The preferred driving motion is in the x direction, however, the motion in z direction can be also deployed. Four hinges 340-343 provide resonating bridge-like geometry that is very stable with respect to undesirable rotational and twisting displacements that are characteristic of standard electrostatic comb actuations with two hinges. The mechanical stops that limit displacements in the driving direction are included in the resonator in FIG. 3, but are omitted for clarity.

The electrical CMOS circuits 370-372, 374-375 and 380-382 are shown adjacent to the resonator in FIG. 3b, but it is preferable to place them below or in the close proximity of the resonator to minimize parasitics and noise pick up and thus maximize signal to noise ratio and the sensitivity.

The electric driving voltage waveforms are applied between the movable teeth 366 and the stationary teeth 364 to move the plate 302 in the positive x direction or between the movable teeth 367 and the stationary teeth 365 to move the plate in the negative x direction. The driving amplifiers 374 and 375 are controlled by the system controller 377 fabricated in CMOS. This way, the movable structure 302+320+321+366+367 can be set into vibrations in x direction when the driving waveform is oscillatory. The sensing is performed by using the signal generated between the movable teeth 320+321 and the stationary teeth 332 and 333 and amplifying the signals with the amplifiers 380 and 381 and processed with the system controller 377.

Alternatively, the movable plate 302+320+321 can be set into motion in positive y direction by applying the driving signals between the driving electrode 330 with stationary teeth 332 and movable teeth 320 using the driving amplifier 370. Similarly, for driving in the negative y direction, the driving waveform is applied between electrode 331 with stationary teeth 333 and movable teeth 321 using the amplifier 371. The sensing signals between the movable teeth 366+367 and stationary teeth 364+365 are amplified with sensing amplifiers and processed with the system controller 377.

When the driving waveform is bipolar and the movable structure oscillates between positive and negative x or y directions, the sensing signals are increased by about a factor of two compared with unipolar driving. The driving and sensing circuits can be electrically separated and consequently, the noise level is lowered and the detection sensitivity increased.

Alternative driving in the x-direction, that is not shown in FIG. 3, uses stationary teeth 332 and 333 that are each split into two electrically separate but symmetric parts. Odd half teeth parts are electrically interconnected together while even half teeth parts are connected together. The displacement in the positive x-direction is accomplished by applying the voltage between one set of interconnected half teeth and the movable teeth 320 and 321 and the displacement in the negative x-direction by applying the voltage between the second set of interconnected half teeth and the movable teeth 320 and 321. In this case, the sensing is performed between the stationary teeth 364 and/or the movable teeth 366 and the stationary teeth 365 and the movable teeth 367.

The sensing and driving circuits can also be electrically connected to the comb device so that the movable comb structures are forced to move in out-of-plane direction, z, with respect to the stationary combs, instead of lateral x or y directions described above. In such cases, the stationary teeth 332 and 333 and teeth 364 and 365 can be electrically interconnected. The movable teeth can be displaced with respect to stationary teeth in the z direction which is normal to the substrate in order to create the asymmetric fringing field between stationary and movable teeth and allow initial motion in the z direction normal to the substrate. This can be accomplished by having different height of stationary and movable teeth, having effectively the static z displacement between stationary and movable teeth. In the extreme case, the z displacement between stationary and movable teeth can be equal to the height of the movable teeth. These variants for out-of-plane comb resonant motion can be accommodated by the fabrication that builds stationary and movable combs in the same plane with slight z offset for these two sets of combs or in two totally different z planes.

The adsorption/reaction of ligand m, marked as 310, residing anywhere on the movable structure 301+320+321 leads to decrease of the resonant frequency by Δf₁. The frequency changes can be detected with the larger signal to noise ratio in this comb resonator 300 with the large number of movable teeth because of the large capacitance between the static and movable teeth compared with the one movable teeth structure or electrostatic parallel plate actuator.

When excessive driving voltages are applied between the movable and stationary parts of the sensor, the movable portion can become unstable and displace so far that the electrical contact occurs between the movable and stationary parts of the structure, leading to the electrical short. In order to prevent such an occurrence, the mechanical stops are placed outside of two or four corners of the movable teeth at the distance equal to about half of the gap between the movable and stationary teeth. When the movable structure is displaced by driving voltages about half of the gap, the mechanical stops prevent the movable section to go any further and electrical short between the movable and stationary teeth is prevented. Normally, these mechanical stops will have the same potential applied to them as the potential of the movable teeth. The mechanical stops can be interconnected to the system electronics 377 and used to detect the mechanical and electrical contact between the movable teeth and the mechanical stops and subsequently used to calibrate or optimize the driving waveforms.

When the ligands are introduced in the gas phase, molecules present in the ambient or in the specific gaseous environment can be identified. When the unknown biological ligands are brought into contact with comb resonator in aqueous or other liquid environment, the unknown biological species can be identified in principle. Consequently, the vibrating comb structure serves as a basic element of the nano mass spectrometer for identification of chemical and biological species. Nano mass spectrometer is defined here as the sensor that measures very small changes in its mass as a result of interaction of the ligands with specific receptors on sensor and allows identification of the ligands.

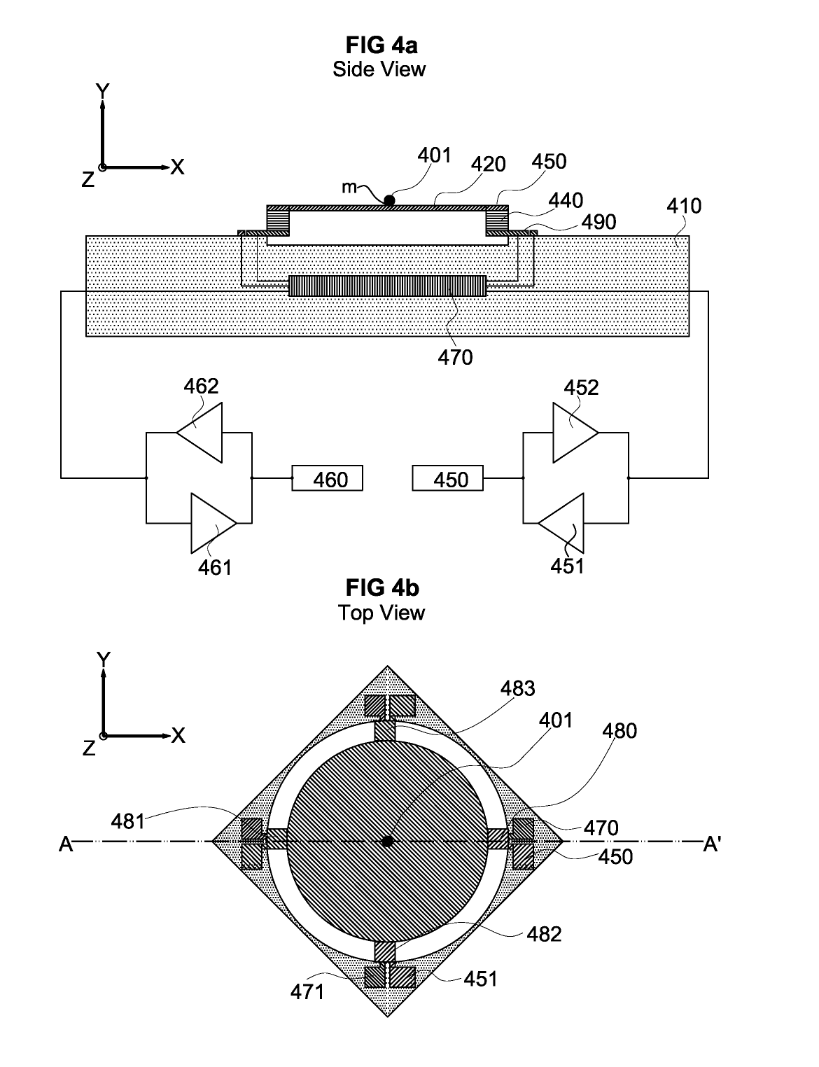

When sensing at high frequencies is preferable, the sensors based on piezo-electric resonators as disclosed in Utility patent application Ser. No. 13/209,442 can be used. The side view of the piezo resonator is shown in FIG. 4a and the top view in FIG. 4b. The piezoelectric resonators without dependence of resonant frequency on the position of the added mass can be realized by structures where piezoelectric material 440 with surrounding electrodes are limited to tethers 480-483. The resonating structure is completed by the plate 420 which resides above the cavity.

The driving electrical pads such as 470 are connected to the bottom electrodes of the piezoelectric layer 440 and the driving electrical pads such as 450 are connected to the top electrodes. The sensing electrical pads such as 471 and 451 are connected to two electrodes surrounding the piezoelectric layer 440. In another embodiment, the same piezoelectric structures can have dual functionality for driving and sensing. The number of the driving and sensing structures in FIG. 4a-b is only illustrative of the actual number, as it can vary from one to many.

The applied voltage waveform is applied between the electrodes 480+481 and 490 from the amplifiers 452 and 462 that are driven by the controller 450 and 460 respectively. As a result of applied voltage across the piezoelectric film 440, the material will undergo in-plane or out-of-plane expansion or shrinkage. The periodic driving voltage at frequencies that correspond to the mechanical resonances of the structure will result in maximum vibrational response of the resonator. The sensing is performed by detecting the signal from electrode-piezo film-electrode structure 483+482 and amplifying the signal using amplifiers 451 and 461.

The CMOS circuit 470 represents the amplifiers 451, 461, 452 and 462 and processors 450 and 460. It is connected to the electrodes by vias formed during monolithic fabrication of CMOS and NEMS or by electrical interconnects formed during bonding of CMOS and NEMS wafers.

The energy losses of the piezoelectric resonators or the broadening of resonant peaks can be reduced by the selection of piezoelectric material, by control of its microstructure during deposition, by the selection of electrode materials and control of the piezoelectric-electrode interfaces. When the electrodes do not reside directly on the piezoelectric surfaces but are spaced by air or vacuum gap, the broadening of the resonant peaks can be further reduced. The different resonant modes can be excited with the external driving voltage waveforms. The lateral breathing modes with in-plane motion have typically lower resonant losses than the motion in the direction normal to the plane of the resonator. The poling of the piezo materials with the large external field sets the direction of the permanent electric field and allows control of the specific resonances. The electric field poling can be performed at elevated temperatures and at high electric fields.

In order to keep very high sensitivity of the piezoelectric sensors and at the same time achieve very high resonant frequencies, the mass of the plate 420 should be minimized while imparting high stiffness to the suspending tethers. This can be accomplished by keeping the area and thickness of the plate 420 small and by decoupling of the plate thickness and thickness of electrode-piezo film-electrode structure. This modification of the vibrating structure will increase the complexity of the sensor and its fabrication somewhat by adding a deposition, lithography and etching steps, but it will result in improved performance.

When the mass is added to the resonator, its resonant frequency will shift downward and the mass of the adsorbed or reacted species can be determined. The resolution of the sensors depends on the broadening of the resonant peaks compared with the resonant frequency. The overall broadening of resonance is the result of internal energy losses of the resonant structure and external loss effects from damping of viscous media surrounding the resonator. The effect of viscous media damping decreases with increasing resonant frequency. The small, high stiffness electrostatic resonators have typical resonant frequencies in 1 MHz to 1 GHz range. The resonant frequencies of the piezoelectric sensor can typically be in 1 to 30 GHz range. Consequently, the broadening of the piezoelectric resonant peaks due to external damping is much lower than the broadening of the resonant response of electrostatic sensors relative to their resonant frequencies. The damping effects and resonant broadening can be further reduced by employing lateral resonant motion in x-y plane shown in FIG. 4 and control of the resonator environment described below.

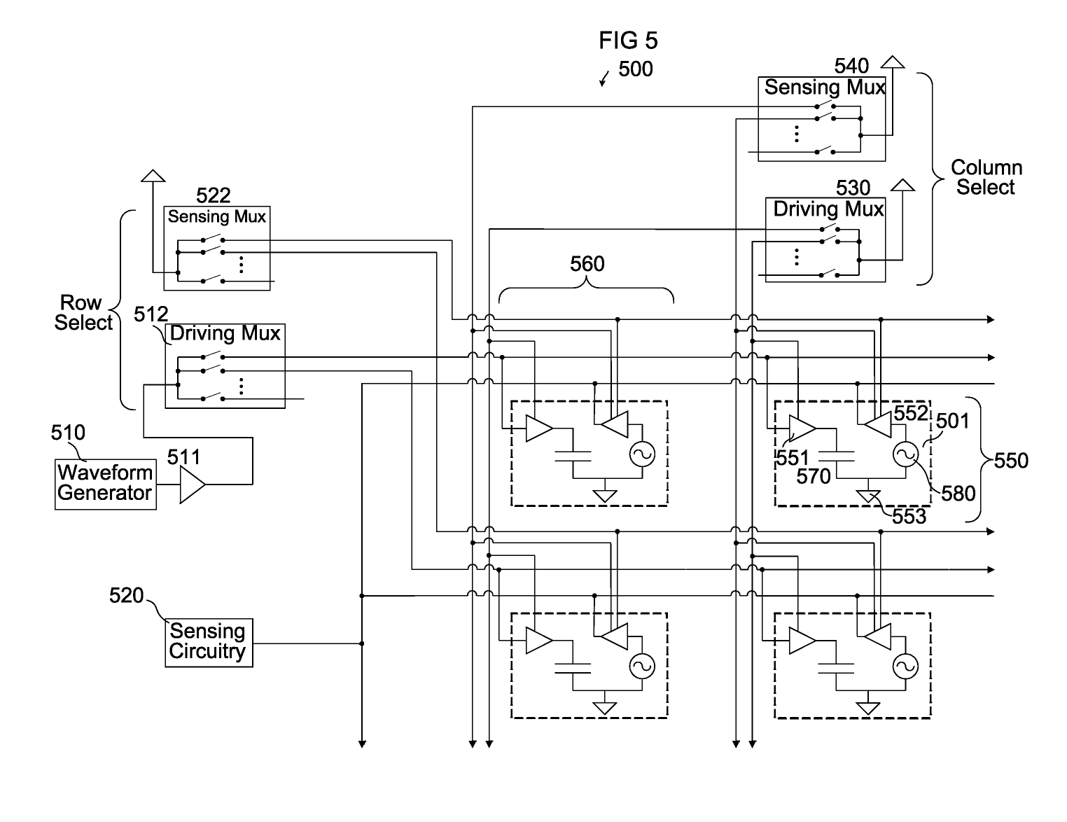

In order to detect the specific agents sensitively, the large array of sensors can be built. When there are N sensors built into the sensing system, the signal to noise ratio is improved by √N. In one implementation, each sensor has its own detection circuitry associated with it. When the detection circuitry occupies larger area than the area occupied by several sensors, one or several detection circuits can serve multiple resonators as shown schematically in FIG. 5.

Multiple sensors can be used to increase measurement accuracy, and/or improve the signal to noise ratio. FIG. 5 shows a high level schematic representation of the detection circuitry for electrostatic comb or piezoelectric resonators. The resonators 501 are arranged in the x-y matrix with the rows 550 and columns 560. The sensing element 570 of the sensor 501 is represented by capacitor of varying capacitance. The driving element 580 of the resonator 501 is depicted by an oscillator. The driving element 580 and the sensing element 570 share a common potential 553. In this schematic, the potential is represented as a ground symbol but the actual voltage potential will be based on various system design parameters. The drive amplifier 551 is shown with an enable signal on corresponding driving column select multiplexer 530 and the driving row select multiplexer 512 to selectively enable the waveform on the driving element of a given sensor. The sense amplifier 552 is shown with an enable signal on corresponding sensing column select multiplexer 540 and the sensing row select multiplexer 522 to selectively enable the sensing signal of a given sensor to provide signal to the sensing circuitry 520. There are several ways to connect multiple sensors and multiplex the input signals. It is often preferable to drive multiple sensors simultaneously and to sense the outputs simultaneously or sequentially. Increased accuracy can be achieved by driving multiple sensors and selectively enabling various groups of sense outputs. This schematic is used to demonstrate the basic principle of operation and does not necessarily represent the preferred embodiment. Also, the sensing signals could be potentially measured through Radio Frequency (RF) means without the need for physical interconnect wires.

Measuring the frequency of the vibrating elements of the NEMS device has a number of advantages including the ability to mix and/or compare a large number of sensors simultaneously without frequency matching errors from multiple oscillators. The oscillator signals from the multiple sensors can be combined and the desired frequencies extracted through digital signal processing means.

Binding interaction of the ligands extracted from the tested sample with receptors placed on the sensor has to be immune to common interferants. The physical adsorption or chemical reaction has to be specific to the combination of receptors and ligands. In addition, the probability of the interaction or reaction should be as high as possible so that the sensitivity is high.

The most desirable sensing architecture allows one detection circuit per one sensing resonator. Such architecture permits detection with best signal/noise ratio because it has the minimal parasitics and low noise and also the fastest data acquisition. When one detection circuit serves several resonators, the multiplexer is used, as described above, which leads to increased noise and data acquisition time that is roughly equal to the data acquisition time per resonator multiplied by the number of resonators per detection circuit. The typical area occupied by the resonator is between 1 and 1000 um², and therefore for one detection circuit per resonator, the circuit has to fit into the same area, which is challenging even with high resolution CMOS at the low end of the areal range. Consequently, the circuit has to be simple with few electrical elements while allowing high sensitivity. The detection circuitry should also be operating at low voltage in order to further reduce the footprint of single detection circuit.

It is desirable to design the resonant frequency of the sensing structure as high as possible, typically from 1 MHz to 1 GHz for electrostatic resonators and from 1 GH to 30 GHz for piezoelectric resonators. The adsorption or reaction of the single ligand on the sensor is going to decrease the resonant frequency typically by 1 Hz to 1 MHz. Typical required sensitivity ranges from 1 part per thousand to 1 part per billion. The direct measurement of absolute frequencies and/or phase is possible, but it would be susceptible to error, noise and manufacturing tolerances. It would not have enough resolution or would require very long acquisition times, and for this reason, the detection based on comparison of signals before and after interaction of ligands with receptors for reference and sample resonators is the preferred method.

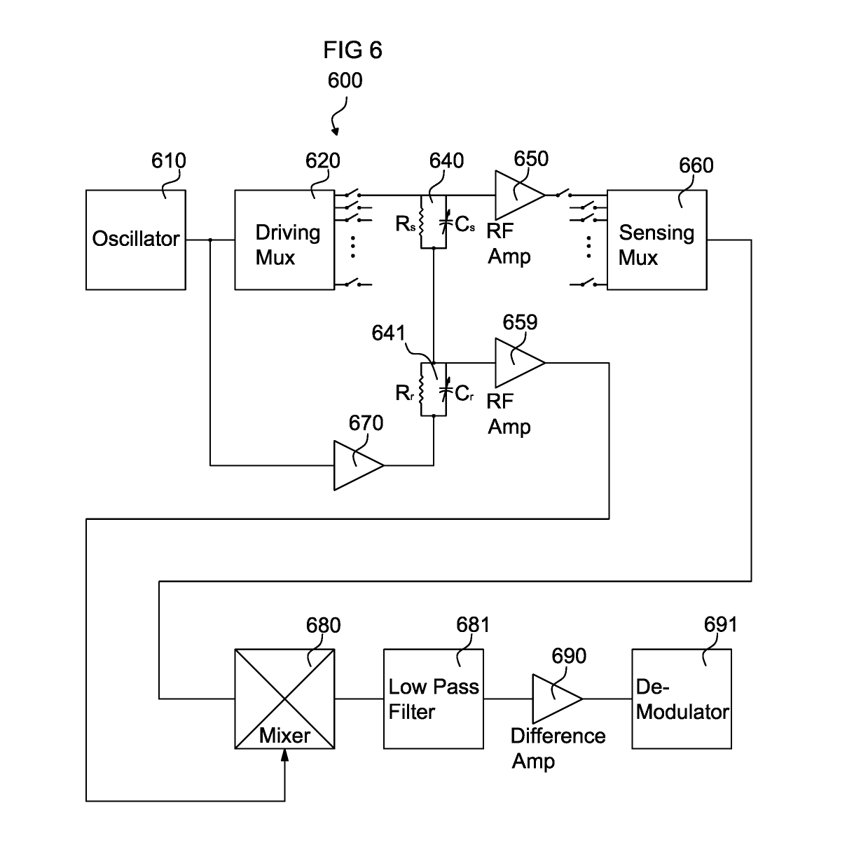

An example of simplified electrical CMOS circuitry for detection of small, relative changes of frequency of sample sensors is outlined in FIG. 6. The resonant structures of sample sensors 640 and reference sensor 641 are represented by simplified resistance-capacitance equivalent circuits, RₛCₛ and RᵣCᵣ respectively. The oscillator 610 establishes the resonant frequency of the sample sensor 640 by driving the frequency sweep and monitoring output voltages of the sample sensor, after amplification of sensor signal with amplifier 650. The driving multiplexer 620 can switch between different sensors 640 and sensing multiplexer 660 can switch signals from different sample sensors. The sample sensors are then normally driven at or near the resonant frequency f of the sensor. The reference sensor 641 is driven at the same frequency from the same oscillator 610, after inverting the oscillator signal with inverter 670. The reference sensor signal is amplified with the amplifier 659 and sent into mixer 680 where it is mixed with the sample sensor signal. The described detection principle follows superheterodyne technique of detection of the amplitude or phase modulation which leads to determination of the frequency difference after passing the signal through the low pass filter 681, the difference amplifier 690 and demodulator 691. The driving and sensing of the sample and reference resonators can be performed with or without multiplexing, depending on whether the electrical circuit fits in the similar area as the resonator.

The sensed voltages of sample sensors before exposure of ligands to receptors Vs_{b} and reference sensor voltages V_{rb} are mixed or beaten against each other, producing the signal modulated at frequency Δf_{b}=f_{sb}−f_{rb}, where f_{sb} and f_{rb} are sample and reference resonant frequencies before exposure. The same signal mixing and measurement are repeated after exposure of ligands to receptors, generating the signal modulated at frequency Δfₐ=fₛₐ−fᵣₐ, where fₛₐ and fᵣₐ are sample and reference frequencies after exposure. The references do not change during short period of time between two measurements, thus fᵣₐ=f_{rb}. The sample resonant frequency changed by Δf=fₛₐ−f_{sb} as a result of increased mass by m, where Δf=fₛₐ−f_{sb}=Δfₐ−Δf_{b}. The effective capacitance of sample sensors and reference sensors is very small, in attoFarad (10⁻¹⁸) to femtoFarad (10⁻¹⁵) range. For this reason, the parasitic impedances, including parasitic capacitances have to be minimized by placing the detection Complementary Metal Oxide Semiconductor (CMOS) circuitry below, above or adjacent to the NEMS sensor in the close proximity.

As the frequency of the oscillator is swept in the narrow range around the resonant frequency or its harmonic, the signal amplitude from the resonator 640 and the phase φ vary rapidly as shown in FIG. 2. In the preferred embodiment, when the phase reaches the value set in the comparator, time of this occurrence is registered and converted to the frequency, f.

Alternatively, the phase comparator can be substituted by the signal amplitude comparator, even though its performance is more sensitive to calibration errors, variability of resonators and detection circuits and drifts than the phase comparator.

The detection of one threshold with the comparator does not provide the ultimate resolution of the frequency shift Δf in FIG. 2. When multiple scans of frequency are combined with changes of comparator phase values or signal amplitudes in subsequent scans, the full dependence of the phase φ or amplitude in FIG. 2 can be detected, allowing the fit of the full dependence of the phase φ or amplitude versus the frequency and thus yielding very sensitive measurement of the frequency f_{b} before the interaction of ligands with receptors and the frequency fₐ after the interaction of the ligands with receptors.

In order to cancel out drifts due to temperature, water molecule adsorption, and other factors, the resonant frequencies of sample resonators that are exposed to ligands and resonant frequencies of reference resonators that are not exposed to ligands but to environment in which ligand is present, are detected before and after exposure, yielding resonant frequencies f_{sb}, fₛₐ, f_{rb} and fᵣₐ respectively.

The fabrication of the integrated sensor that contains NEMS sensor and CMOS detection circuitry can be done monolithically by fabricating CMOS and NEMS on one wafer sequentially or by electrically bonding the NEMS and CMOS wafers that were fabricated separately, allowing wafer level packaging and testing at low cost. Alternative option involves fabrication of the NEMS and CMOS wafers individually, dicing wafers into dies and stacking and wire bonding the NEMS and CMOS dies together. The sensing chamber with the seal and input and output openings can be formed by wafer level bonding before or after attachment of or coating of NEMS resonators with receptors in the process referred to as functionalization.

In order to achieve very high sensitivity, the resonance of the resonator has to have as high quality factor as possible. The quality factor, Q, is usually defined as the ratio of the resonant frequency divided by the width of the resonant peak in the frequency domain, Δf_{w},

Q=f/Δf_{w}.

The quality factor reflects energy losses in the resonating structure, being high for the resonators with the low energy loss.

The mass, m that can be resolved is proportional to

m=M/Q,

the ratio of the effective mass of the sensor M and quality factor Q.

The quality factor Q of the resonator is typically between several 1000's and 100000 in the vacuum or low pressure and it decreases by a factor of 10 to 1000 in air at ambient pressures and by a factor of 1000 or more in the liquids. All species of interest here are present either in the gaseous form or liquid form and the detection with the gas or liquid surrounding the resonators would yield lower resolution of detectable species.

In order to achieve high sensitivity, the vacuum environment has to be created after exposure of the sensors to the species to be detected. Additionally, it is required to have ligand-receptor interactions that are not reversed when the resonator with ligand-receptor pairs is exposed to suspending liquid removal, pumping or vacuum.

Moreover, when the resonator is exposed to the liquids that are subsequently removed, the capillary forces created by the contact between liquid and solid are strong enough to displace or distort the resonator so much that the permanent static forces (stiction) can bring movable parts into contact with stationary parts of the resonator and keep the movable part of resonator in the solid contact with the surroundings, making the resonator inoperable. In other cases when extreme stiction does not occur, the resonant structure may be distorted and the resonant frequency altered, making such a sensor unsuitable for detection. The removal of liquids and transition to vacuum or lower pressure has to be managed so that these degradation mechanisms are avoided or minimized.

The solutions allowing preservation of high Q factor for the measurements, after exposure of sensors to the liquid, rely on freeze drying or critical point drying.

In freeze drying, the material is brought around the triple point, avoiding the direct liquid-gas transition typical in normal drying. It is important to cool the material below its triple point, the lowest temperature at which the solid, liquid and gas phases of the material coexist. This ensures that sublimation rather than melting will occur in the following steps.

The freezing can be done rapidly so that formation of larger crystals that can damage the biological materials or NEMS structures is avoided. In addition, the sampling volumes and the gap between the resonator and the cavity surfaces are very small, thus limiting formation of ice crystallites. Usually the freezing temperatures below −10 deg C. are used for water based samples. During the primary drying phase, the pressure is lowered and enough heat is supplied for the ice to sublimate. The amount of heat necessary is determined by the sublimating molecules' latent heat of sublimation.

The secondary drying phase aims to remove remaining adsorbed water molecules, since the ice was removed in the primary drying phase. This part of the freeze-drying process is governed by the material's adsorption isotherm. In this phase, the temperature is raised higher than in the primary drying phase, and can even be above 0 deg C. for water based samples, to break any physical and chemical interactions that have formed between the water molecules and the frozen material. Usually the pressure is low during this stage to encourage desorption.

In the critical point drying, the initial liquid containing ligands is substituted in multiple steps or in continuously varying steps with the mixture of the initial liquid and the second liquid until the initial liquid is completely removed. The second liquid is chosen so that it has the coexistence of liquid and its gas simultaneously at critical temperature which allows the liquid removal without condensation of the second liquid and without appearance of capillary forces responsible for stiction. The critical point drying process is often used to remove liquid after the functionalization of resonators with receptors. Multiple liquids can be employed if the simple critical drying with two liquids is not adequate.

Another condition has to be satisfied with these sensors. Preferably no or minimal number of reacted ligand-receptor pairs or reacted ligands should be removed from the sensor in the process of critical point drying or freeze drying. When the second liquid is completely removed, the gas of the second suspending liquid is pumped out so that the vacuum or lower pressure environment is created for sensing. The temperature of the system can be raised moderately, so that gas and suspending liquid adsorbed on the sensor is removed and the speed of removal is accelerated. The temperature can be only high enough not to lead to the thermal desorption of reacted ligand-receptor pairs or to their degradation.

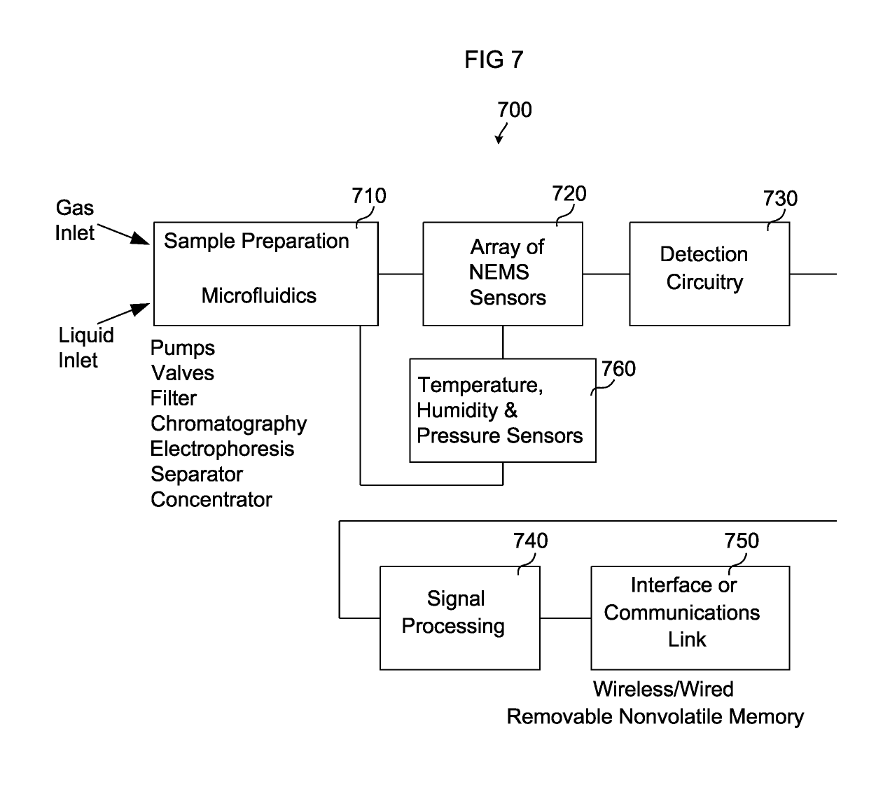

The system architecture for the detection of chemical and biological species is shown in FIG. 7. The system has the front end that includes sample introduction or preparation 710, array of NEMS sensors 720, and electrical circuitry 730 described above and the back end that includes signal processing 740 and interface or communication links 750. The front end that is dedicated to the sample preparation and delivery in the gas or liquid state, may include, apart from microvalves and micropumps, also device for gas or liquid chromatographic separation or electrophoretic separation or the concentrator. In order to facilitate the sample handling and lower pressure environment for sensing and/or removal of liquid, the pressure, relative humidity and temperature sensors 760 are generally included.

The sensor is normally enclosed in the sealed package or in the package that has the valves closed before the initiation of detection. When it is desired to use the sensor, the seal is broken or the valve is open and the sensor is exposed to external environment, such as for detection of gaseous species—ozone, explosive vapors, breath, etc. or to the detection of species suspended in the liquid.

The above described sensing capabilities can find useful applications in personalized medicine. The personalized medicine would require detailed and frequent analysis of patient's blood or other liquids such as saliva, urine or gases such as breath, anywhere and anytime, preferably away from the diagnostics lab. In personalized medicine, drugs are optimized and administered according to each individual's unique genetic makeup when needed, as a result of on demand testing. The sensing sub-system can be also used as a monitor of concentration of drugs in the patient, forming a part of the system that controls introduction of medicine to the patient in the closed loop servo system.

Personalized medicine transforms medicine from prescribing treatment based on patient's symptoms to therapies based on patient's genetics and individualized needs. It promises to treat diseases more effectively and alleviate symptoms.

The above described NEMS sensors make medical diagnostics very sensitive, specific with low level of false positives and negatives, fast, inexpensive, portable, wireless and therefore useful for personalized medicine. The other applications of these NEMS sensors include personal wellness monitoring, such as detection of oxidative stress, antioxidants, detection of explosives, drugs, chemical and biological weapons, environmental pollution, water contaminants and others.

What is claimed is:

1. An electrostatic sensor comprising;
a. a resonator with movable and stationary structures that are mechanically connected and electrically isolated,
b. movable structure having a flexible part and a rigid plate suspended by a flexible part,
c. a plate having receptors attached to it,
d. a circuit to set movable structure into vibration,
e. a phase or signal comparator circuit to determine the change in vibration of the plate due to interaction of receptors and ligands.

2. A method for detecting and identifying the presence of a ligand using;
a. an electrostatic sensor of claim 1,
b. driving the sensor to set the plate into vibration,
c. determining vibrational behavior of the plate,
d. introducing a ligand to the sensor,
e. determining the change in vibrational behavior of the plate,
f. determining the presence of a ligand.

3. A piezoelectric sensor comprising;
a. a resonator with piezoelectric material between two electrodes and a plate,
b. a plate having receptors,
c. a circuit to set piezoelectric structure into vibration,
d. a phase or signal comparator circuit to determine the change in vibration of the plate due to interaction of receptors and ligands.

4. A method for detecting and identifying the presence of a ligand using;
a. the sensor of claim 3,
b. driving the sensor to set the plate into vibration,
c. determining vibrational behavior of the plate,
d. introducing a ligand to the sensor,
e. determining the change in vibrational behavior of the plate,
f. determining the presence of a ligand.

5. A device for detecting and identifying the presence of a ligand comprising;
a. sample sensor and reference sensor of claim 1,
b. electrical oscillator driving sample and reference sensors,
c. mixer to beat sample and reference sensor signals against each other,
d. phase or signal comparator to determine resonant frequency difference between the sample and reference sensors.

6. A device for detecting and identifying the presence of a ligand comprising;
a. sample sensor and reference sensor of claim 3,
b. electrical oscillator driving sample and reference sensors,
c. mixer to beat sample and reference sensor signals against each other,
d. phase or signal comparator to determine resonant frequency difference between the sample and reference sensors.

7. A device for detecting and identifying the presence of a ligand comprising;
a. sample sensors and at least one reference sensor of claim 1,
b. electrical oscillator driving sample and reference sensors,
c. phase or signal comparator based detection circuit to determine difference in resonant frequencies of sample and reference sensors,
d. addressing matrix to select sample and reference sensors,
e. multiplexer to connect selected sample sensors to detection circuit.

8. A device for detecting and identifying the presence of a ligand comprising;
a. sample sensors and at least one reference sensor of claim 3,
b. electrical oscillator driving sample and reference sensors,
c. phase or signal comparator based detection circuit to determine difference in resonant frequencies of sample and reference sensors,
d. addressing matrix to select sample and reference sensors,
e. multiplexer to connect selected sample sensors to detection circuit.

9. A method for detecting and identifying the presence of a ligand using;
a. an electrostatic sensor of claim 1,
b. providing a signal with a frequency component to set the movable structure into vibration and measuring a phase or amplitude of a first electrical signal of the movable structure,
c. introducing a ligand to the sensor,
d. providing a signal with a frequency component to set the movable structure into vibration and measuring a phase or amplitude of a second electrical signal of the movable structure,
e. determining the presence of a ligand on the movable structure of an electrostatic sensor by comparing the first and second electrical signals of the movable structures.

10. A method for detecting and identifying the presence of a ligand using;
a. a piezoelectric sensor of claim 3,
b. providing a signal with a frequency component to set the movable structure into vibration and measuring a phase or amplitude of a first electrical signal of the movable structure,
c. introducing a ligand to the sensor,
d. providing a signal with a frequency component to set the movable structure into vibration and measuring a phase or amplitude of a second electrical signal of the movable structure,
e. determining the presence of a ligand on the movable structure of a piezoelectric sensor by comparing the first and second electrical signals of the movable structures.

11. A method for detecting and identifying the presence of a ligand using;
a. receptors attached to the movable structures of two or more electrostatic sensors of claim 1,
b. introducing a ligand to one or more sensors,
c. providing a signal with a frequency component to set two or more movable structures into vibration,
d. measuring a phase or amplitude of two or more frequency components of the electrical signals of the movable structures,
e. determining the presence of a ligand on a movable structure of a sensor by comparing phase or amplitude of two or more frequency components of the electrical signals.

12. A method for detecting and identifying the presence of a ligand using;
a. receptors attached to the movable structures of two or more piezoelectric sensors of claim 3,
b. introducing a ligand to one or more sensors,
c. providing a signal with a frequency component to set two or more movable structures into vibration,
d. measuring a phase or amplitude of two or more frequency components of the electrical signals of the movable structures,
e. determining the presence of a ligand on a movable structure of a sensor by comparing phase or amplitude of two or more frequency components of the electrical signals.

13. A method for detecting and identifying the presence of a ligand using;
a. an electrostatic sensor of claim 1,
b. introducing a ligand to the sensor,
c. providing a signal with a frequency component to set a first movable structure into vibration and measuring a phase or amplitude of a frequency component of a first electrical signal of a first movable structure,
d. providing a signal with a frequency component to set a second movable structure into vibration and measuring a phase or amplitude of a frequency component of a second electrical signal of a second movable structure,
e. determining the presence of a ligand on a movable structure of a sensor by comparing phase or amplitude of frequency components of the first and second electrical signals.

14. A method for detecting and identifying the presence of a ligand using;
a. a piezoelectric sensor of claim 3,
b. introducing a ligand to the sensor,
c. providing a signal with a frequency component to set a first movable structure into vibration and measuring a phase or amplitude of a frequency component of a first electrical signal of a first movable structure,
d. providing a signal with a frequency component to set a second movable structure into vibration and measuring a phase or amplitude of a frequency component of a second electrical signal of a second movable structure,
e. determining the presence of a ligand on a movable structure of a sensor by comparing phase or amplitude of frequency components of the first and second electrical signals.

15. The chemical or biological sensing system comprising:
a. electrostatic sensors of claim 1 containing receptors,
b. electrical oscillator circuit for driving of multiple resonators simultaneously or in groups or individually,
c. phase or amplitude detection circuit to determine resonant frequency of sample and reference signals,
d. microfluidic subsystem for gaseous sampling
e. subsystem for determination of differences between resonant frequencies of sample and reference sensors before and after introduction of ligands.

16. The chemical or biological sensing system comprising:
a. electrostatic sensors of claim 1 containing receptors,
b. electrical oscillator circuit for driving of multiple resonators simultaneously or in groups or individually,
c. phase or amplitude detection circuit to determine resonant frequency of sample and reference signals,
d. microfluidic subsystem for liquid sampling and optional critical point drying or freeze drying,
e. subsystem for determination of differences between resonant frequencies of sample and reference sensors before and after introduction of ligands.

17. The chemical or biological sensing system comprising:
a. piezoelectric sensors of claim 3 containing receptors,
b. electrical oscillator circuit for driving of multiple resonators simultaneously or in groups or individually,
c. phase or amplitude detection circuit to determine resonant frequency of sample and reference signals,
d. microfluidic subsystem for gaseous sampling
e. subsystem for determination of differences between resonant frequencies of sample and reference sensors before and after introduction of ligands.

18. The chemical or biological sensing system comprising:
a. piezoelectric sensors of claim 3 containing receptors,
b. electrical oscillator circuit for driving of multiple resonators simultaneously or in groups or individually,
c. phase or amplitude detection circuit to determine resonant frequency of sample and reference signals,
d. microfluidic subsystem for liquid sampling and optional critical point drying or freeze drying,
e. subsystem for determination of differences between resonant frequencies of sample and reference sensors before and after introduction of ligands.
